(19) United States
(12) Patent Application Publication
(10) Pub. No.: US 2020/0378769 A1
(43) Pub. Date: Dec. 3, 2020

(54) INTELLIGENT ROUTE NAVIGATION METHOD AND DEVICE, SERVER, MOBILE TERMINAL, AND STORAGE MEDIUM

(71) Applicant: ZICT Technology Co., Ltd, Shenzhen (CN)

(72) Inventor: Chang Liu, Shenzhen (CN)

(73) Assignee: ZICT Technology Co., Ltd, Shenzhen (CN)

(21) Appl. No.: 16/766,340

(22) PCT Filed: Jul. 9, 2018
(86) PCT No.: PCT/CN2018/095002

§ 371 Date: May 22, 2020

(30) Foreign Application Priority Data
Nov. 30, 2017 (CN) 201711236082.X

(51) Int. Cl. G01C 21/34

(52) U.S. Cl. CPC G01C 21/343; G01C 21/3446; G01C 21/3461

(57) ABSTRACT

Disclosed are an intelligent route navigation method and device, a server, a mobile terminal and a storage medium. The method includes acquiring current geographic location information of a client and tag attribute information sent by the client; determining information about at least one destination in a preset database according to the tag attribute information and the current geographic location information; parsing information about each destination to determine at least one piece of characteristic tag information corresponding to the information about each destination; selecting information about a plurality of recommended destinations according to a degree of matching between the at least one piece of characteristic tag information corresponding to the information about each destination and the tag attribute information; and generating intelligent route navigation according to the current geographic location information and the information about the plurality of recommended destinations and sending the intelligent route navigation to the client.

This application claims priority to a Chinese patent application No. 201711236082.X filed on Nov. 30, 2017, entitled “INTELLIGENT ROUTE NAVIGATION METHOD AND DEVICE, SERVER, MOBILE TERMINAL, AND STORAGE MEDIUM”, disclosure of which is incorporated herein by reference in its entirety.

### TECHNICAL FIELD

The present application relates to the field of intelligent travel, for example, to an intelligent route navigation method, an intelligent route navigation device, a server, a mobile terminal and a computer-readable storage medium.

### BACKGROUND

With the economic and social development, tourism has become one of the strongest and largest industries in the world. The industrial status and role of tourism in the development of urban economy have been gradually strengthened. Tourism plays an increasingly apparent role in boosting urban economy, driving social employment and promoting culture and environment. As tourist destinations are enriched rapidly, a tourist cannot design the route efficiently at a tourist destination. It is urgent to provide a method of automatically recommending the most suitable route according to the preference of a tourist and navigating the tourist to a strange place to be visited.

However, in the related art, conventional navigation software generally plans a route for navigation through GPS data according to the origin and the destination inputted by a user. Depending on the geographic location information or detailed name information of a destination inputted by the user, the conventional navigation software has the disadvantages described below.

(1) In the case where the user does not know the origin or the destination, the software cannot handle the case efficiently and cannot satisfy the user's urgent need for a method of automatically recommending a route according to the user's preference in a strange place.

(2) The route planning is not systematically integrated with the local tourism physical resources and information resources and thus the route navigation is unreasonable to some extent.

### SUMMARY

The present application is intended to solve at least one of the problems existing in the related art.

The present application provides an intelligent route navigation method, an intelligent route navigation device, a server, a mobile terminal and a computer-readable storage medium.

The present application provides an intelligent route navigation method, applied to a server. The method includes acquiring current geographic location information of a client and tag attribute information sent by the client; determining information about at least one destination in a preset database according to the tag attribute information and the current geographic location information; parsing information about each destination to determine at least one piece of characteristic tag information corresponding to the information about each destination; selecting information about a plurality of recommended destinations according to a degree of matching between the tag attribute information and the at least one piece of characteristic tag information corresponding to the information about each destination; and generating intelligent route navigation according to the current geographic location information and the information about the plurality of recommended destinations and sending the intelligent route navigation to the client.

In the intelligent route navigation method provided in this embodiment of the present application, the current geographic location information of the client and the tag attribute information sent by the client are acquired to provide data support for intelligent route navigation, helping determine the route satisfying the demand of a user; information about at least one destination is determined in a preset database according to the tag attribute information and the current geographic location information to serve as fundamental data for selection of information about recommended destinations; generally, the geographic location in the information about the at least one destination and the geographic location in the current geographic location information are in the same city; information about each destination is parsed so that characteristic tag information corresponding to the information about each destination is determined; the information about the recommended destinations is selected according to a degree of matching between the tag attribute information and the characteristic tag information corresponding to the information about each destination so that the information about the recommended destinations is determined, helping determine the route satisfying the demand of the user; intelligent route navigation is generated according to the current geographic location information and the information about the recommended destinations, and the intelligent route navigation is sent to the client, so that the route satisfying the demand of the user is planned out and the user is quickly navigated to a destination. Thus, the intelligent route navigation method is applicable to self-service traveling and is intelligent for the user does not need to give a definite destination.

In an embodiment, the tag attribute information includes, but is not limited to, a human landscape, a historical relic, a pirate ship or a seaside recreation site; the characteristic tag information includes, but is not limited to, whether the seaside is near, whether a barbecue site is provided, whether entertainment facilities are available and whether a cinema is available.

In an embodiment, the tag attribute information may be selected by a user from multiple pieces of tag attribute information displayed on the client or may be generated by the client from the text information edited and inputted by the user. After generated, the tag attribute information automatically joins a display queue so as to be selected by the user, helping reduce the cumbersome operation of editing and inputting the text information by the user. Meanwhile, the tag attribute information is easy to identify by a server, helping reduce the data interaction pressure of the server, improve the efficiency of generating intelligent route navigation and quickly navigate the user to a destination.

In an embodiment, selecting the information about the plurality of recommended destinations according to the degree of matching between the tag attribute information and the at least one piece of characteristic tag information corresponding to the information about each destination includes determining the score of each piece of characteristic tag information corresponding to the information about each destination according to the degree of matching between the tag attribute information and the at least one piece of characteristic tag information corresponding to the information about each destination; weighting the score of the at least one piece of characteristic tag information corresponding to the information about each destination to determine the total score of the information about each destination; and sorting total scores of the information about the at least one destination in descending order and selecting information about a preset number of destinations in sequence as the information about the plurality of recommended destinations.

In the intelligent route navigation method provided in this embodiment of the present application, the score of each piece of characteristic tag information corresponding to the information about each destination is determined according to the degree of matching between the characteristic tag information corresponding to the information about each destination and the tag attribute information so that characteristic tag information corresponding to the information about each destination is quantized, helping determine the route satisfying the demand of a user; the score of the at least one piece of characteristic tag information corresponding to the information about each destination is weighted, the total score of the information about each destination is determined, total scores of the information about the at least one destination are sorted in descending order, and information about a preset number of destinations is selected in sequence as the information about the recommended destinations, so that the route better satisfies the demand of the user and the user is quickly navigated to a destination. Thus, the intelligent route navigation method is applicable to self-service traveling and is intelligent for the user does not need to give a definite destination.

In an embodiment, the preset number may be 3 to 5 or the preset number may be set by a user.

In any one of the preceding embodiments, the current geographic location information includes a starting location, and information about each recommended destination includes a target location; and generating the intelligent route navigation according to the current geographic location information and the information about the plurality of recommended destinations and sending the intelligent route navigation to the client includes determining a road condition score corresponding to the information about each recommended destination according to road condition information corresponding to all routes from the starting location to the target location; and sorting all road condition scores corresponding to the information about the plurality of recommended destinations in descending order, generating the intelligent route navigation according to the route corresponding to the maximum road condition score, and sending the intelligent route navigation to the client.

In the intelligent route navigation method provided in this embodiment of the present application, a road condition score corresponding to the information about each recommended destination is determined according to road condition information corresponding to all routes from the starting location to the target location, so that road condition information is taken into account, and thus a route better satisfying the demand of a user is determined; all road condition scores corresponding to the information about the recommended destinations are sorted in descending order, the intelligent route navigation is generated according to the route corresponding to the maximum road condition score, and the intelligent route navigation is sent to the client, so that better intelligent route navigation is provided for the user and the user can be quickly navigated to a destination.

Additionally, after receiving the intelligent route navigation, the user may resend the tag attribute information if the received intelligent route navigation is unsuitable.

In any one of the preceding embodiments, the method further includes changing the intelligent route navigation according to real-time road condition information of all routes from a starting location in real-time geographic location information of the client to the target location in the information about each recommended destination, and sending the changed intelligent route navigation to the client.

In the intelligent route navigation method provided in this embodiment of the present application, the intelligent route navigation is changed according to real-time road condition information of all routes from a starting location in real-time geographic location information of the client to the target location in the information about each recommended destination, and the changed intelligent route navigation is sent to the client, so that better intelligent route navigation is provided for a user, the user is quickly navigated to a destination, and thus unnecessary bypasses taken and unnecessary waiting time consumed on a congested road section are reduced.

The present application provides an intelligent route navigation method, applied to a client. The method includes generating tag attribute information according to a touch instruction of a user for intelligent route navigation, and sending the tag attribute information and current geographic location information to a server, so that the server generates the intelligent route navigation according to the tag attribute information and the current geographic location information; and receiving and displaying the intelligent route navigation sent by the server.

In the intelligent route navigation method provided in this embodiment of the present application, tag attribute information is generated according to a touch instruction of a user for intelligent route navigation, and the tag attribute information and current geographic location information are sent to a server, so that intelligent route navigation is generated by the server according to the tag attribute information and current geographic location information, the route satisfying the demand of the user is planned out, the user is quickly navigated to a destination, and thus the intelligent route navigation method is applicable to self-service traveling and is intelligent for the user does not need to give a definite destination; the intelligent route navigation sent by the server is received and displayed so that the intelligent route navigation is displayed to the user, in one aspect, making it achievable for the user to cancel the intelligent route navigation and resend the tag attribute information when the user feels that the received intelligent route navigation is unsuitable, and in another aspect, making it achievable for the user to view the whole intelligent route navigation and plan a route by himself or herself.

In an embodiment, the tag attribute information includes, but is not limited to, a human landscape, a historical relic, a pirate ship or a seaside recreation site.

In an embodiment, the tag attribute information may be selected by a user from multiple pieces of tag attribute information displayed on the client or may be generated by the client from the text information edited and inputted by the user. After generated, the tag attribute information automatically joins a display queue so as to be selected by the user, helping reduce the cumbersome operation of editing and inputting the text information by the user. Meanwhile, the tag attribute information is easy to identify by a server, helping reduce the data interaction pressure of the server, improve the efficiency of generating intelligent route navigation and quickly navigate the user to a destination.

In an embodiment, the method further includes sending real-time geographic location information to the server, so that the server changes the intelligent route navigation according to real-time road condition information of all routes from a starting location in the real-time geographic location information to a target location in information about each recommended destination; and receiving and displaying the changed intelligent route navigation sent by the server.

In the intelligent route navigation method provided in this embodiment of the present application, real-time geographic location information is sent to the server, so that the server changes the intelligent route navigation according to real-time road condition information of all routes from a starting location in the real-time geographic location information to a target location in information about each recommended destination; the changed intelligent route navigation sent by the server is received and displayed, so that better intelligent route navigation is provided for a user, the user is quickly navigated to a destination, and thus unnecessary bypasses taken and unnecessary waiting time consumed on a congested road section are reduced.

The present application provides an intelligent route navigation device, applied to a server. The device includes an acquisition unit configured to acquire current geographic location information of a client and tag attribute information sent by the client; a determination unit configured to determine information about at least one destination in a preset database according to the tag attribute information and the current geographic location information; a parsing unit configured to parse information about each destination to determine at least one piece of characteristic tag information corresponding to the information about each destination; a selection unit configured to select information about a plurality of recommended destinations according to a degree of matching between the tag attribute information and the at least one piece of characteristic tag information corresponding to the information about each destination; and a generation unit configured to generate intelligent route navigation according to the current geographic location information and the information about the plurality of recommended destinations, and send the intelligent route navigation to the client.

In the intelligent route navigation device provided in this embodiment of the present application, the current geographic location information of the client and the tag attribute information sent by the client are acquired to provide data support for intelligent route navigation, helping determine the route satisfying the demand of a user; information about at least one destination is determined in a preset database according to the tag attribute information and the current geographic location information to serve as fundamental data for selection of information about the plurality of recommended destinations; generally, the geographic location in the information about the at least one destination and the geographic location in the current geographic location information are in the same city; information about each destination is parsed so that at least one piece of characteristic tag information corresponding to the information about each destination is determined; the information about the plurality of recommended destinations is selected according to a degree of matching between the at least one piece of characteristic tag information corresponding to the information about each destination and the tag attribute information so that the information about the plurality of recommended destinations is determined, helping determine the route satisfying the demand of the user; intelligent route navigation is generated according to the current geographic location information and the information about the plurality of recommended destinations and the intelligent route navigation is sent to the client so that the route satisfying the demand of the user is planned out and the user is quickly navigated to a destination. Thus, the intelligent route navigation method is applicable to self-service traveling and is intelligent for the user does not need to give a definite destination.

In an embodiment, the tag attribute information includes, but is not limited to, a human landscape, a historical relic, a pirate ship or a seaside recreation site; the characteristic tag information includes, but is not limited to, whether the seaside is near, whether a barbecue site is provided, whether entertainment facilities are available and whether a cinema is available.

In an embodiment, the tag attribute information may be selected by a user from multiple pieces of tag attribute information displayed on the client or may be generated by the client according to the text information edited and inputted by the user. After generated, the tag attribute information automatically joins a display queue so as to be selected by the user, helping reduce the cumbersome operation of editing and inputting the text information by the user. Meanwhile, the tag attribute information is easy to identify by a server, helping reduce the data interaction pressure of the server, improve the efficiency of generating intelligent route navigation and quickly navigate the user to a destination.

In an embodiment, the determination unit is further configured to determine a score of each piece of characteristic tag information corresponding to the information about each destination according to the degree of matching between the tag attribute information and the at least one piece of characteristic tag information corresponding to the information about each destination; the intelligent route navigation device further includes a calculation unit, configured to weight the score of the at least one piece of characteristic tag information corresponding to the information about each destination to determine a total score of the information about each destination; and the selection unit is further configured to sort total scores of the information about the at least one destination in descending order and selecting information about a preset number of destinations in sequence as the information about the plurality of recommended destinations.

In the intelligent route navigation device provided in this embodiment of the present application, the score of each piece of characteristic tag information corresponding to the information about each destination is determined according to the degree of matching between the tag attribute information and the at least one piece of characteristic tag information corresponding to the information about each destination, so that each piece of characteristic tag information corresponding to the information about each destination is quantized, helping determine the route satisfying the demand of a user; the score of the at least one piece of characteristic tag information corresponding to the information about each destination is weighted to determine the total score of the information about each destination, and total scores of the information about the at least one destination are sorted in descending order and information about a preset number of destinations is selected in sequence as the information about the plurality of recommended destinations, so that the route better satisfies the demand of the user and the user can be quickly navigated to a destination. Thus, the intelligent route navigation method is applicable to self-service traveling and is intelligent for the user does not need to give a definite destination.

In an embodiment, the preset number may be 3 to 5 or the preset number may be set by a user.

In any one of the preceding embodiments, the determination unit is further configured to determine a road condition score corresponding to the information about each recommended destination according to road condition information corresponding to all routes from the starting location to the target location; and the generation unit is further configured to sort all road condition scores corresponding to the information about the plurality of recommended destinations in descending order, generate the intelligent route navigation according to the route corresponding to the maximum road condition score, and send the intelligent route navigation to the client.

In the intelligent route navigation device provided in this embodiment of the present application, a road condition score corresponding to the information about each recommended destination is determined according to road condition information corresponding to all routes from the starting location to the target location, so that road condition information is taken into account and thus a route better satisfying the demand of a user is determined; all road condition scores corresponding to the information about the plurality of recommended destinations are sorted in descending order, and the intelligent route navigation is generated according to the route corresponding to the maximum road condition score and the intelligent route navigation is sent to the client, so that better intelligent route navigation is provided for the user and the user is quickly navigated to a destination.

Additionally, after receiving the intelligent route navigation, the user may resend the tag attribute information if the received intelligent route navigation is unsuitable.

In any one of the preceding embodiments, the device further includes a change unit configured to change the intelligent route navigation according to real-time road condition information of all routes from a starting location in real-time geographic location information of the client to the target location in the information about each recommended destination and send the changed intelligent route navigation to the client.

In the intelligent route navigation device provided in this embodiment of the present application, the intelligent route navigation is changed according to real-time road condition information of all routes from a starting location in real-time geographic location information of the client to the target location in the information about each recommended destination and the changed intelligent route navigation is sent to the client, so that better intelligent route navigation is provided for a user, the user is quickly navigated to a destination, and thus unnecessary bypasses taken and unnecessary waiting time consumed on a congested road section are reduced.

The present application provides an intelligent route navigation device, applied to a client. The device includes a generation unit configured to generate tag attribute information according to a touch instruction of a user for intelligent route navigation, and send the tag attribute information and current geographic location information to a server so that the server generates the intelligent route navigation according to the tag attribute information and the current geographic location information; and a receiving unit configured to receive and display the intelligent route navigation sent by the server.

In the intelligent route navigation device provided in this embodiment of the present application, tag attribute information is generated according to a touch instruction of a user for intelligent route navigation, and the tag attribute information and current geographic location information are sent to a server, so that the route satisfying the demand of the user is planned out, the user is quickly navigated to a destination, and thus the intelligent route navigation method is applicable to self-service traveling and is intelligent for the user does not need to give a definite destination; the intelligent route navigation sent by the server is received and displayed, so that the intelligent route navigation is displayed to the user, making it achievable for the user to cancel the intelligent route navigation and resend the tag attribute information when the user feels that the received intelligent route navigation is unsuitable and making it achievable for the user to view the whole intelligent route navigation and plan a route by himself or herself.

In an embodiment, the tag attribute information includes, but is not limited to, a human landscape, a historical relic, a pirate ship or a seaside recreation site.

In an embodiment, the tag attribute information may be selected by a user from multiple pieces of tag attribute information displayed on the client or may be generated by the client according to the text information edited and inputted by the user. After generated, the tag attribute information automatically joins a display queue so as to be selected by the user, helping reduce the cumbersome operation of editing and inputting the text information by the user. Meanwhile, the tag attribute information is easy to identify by a server, helping reduce the data interaction pressure of the server, improve the efficiency of generating intelligent route navigation and quickly navigate the user to a destination.

In an embodiment, the device further includes a sending unit configured to send real-time geographic location information to the server so that the server changes the intelligent route navigation according to real-time road condition information of all routes from a starting location in the real-time geographic location information to a target location in information about each recommended destination; and the receiving unit is further configured to receive and display the changed intelligent route navigation sent by the server.

In the intelligent route navigation device provided in this embodiment of the present application, real-time geographic location information is sent to the server so that the server changes the intelligent route navigation according to real-time road condition information of all routes from a starting location in the real-time geographic location information to a target location in information about each recommended destination; the changed intelligent route navigation sent by the server is received and displayed so that better intelligent route navigation is provided for a user, the user is quickly navigated to a destination, and thus unnecessary bypasses taken and unnecessary waiting time consumed on a congested road section are reduced.

The present application provides a server. The server includes a processor which is configured to perform, when executing a computer program stored in a memory, the intelligent route navigation method applied to a server as described in any one of the preceding embodiments.

In the server provided in this embodiment of the present application, the server includes a processor which is configured to perform, when executing a computer program stored in a memory, the intelligent route navigation method applied to a server as described in any one of the preceding embodiments. Thus, the server has all beneficial effects of the intelligent route navigation method applied to a server as described in any one of the preceding embodiments. The beneficial effects will not be repeated here.

The present application provides a mobile terminal. The mobile terminal includes a processor which is configured to perform, when executing a computer program stored in a memory, the intelligent route navigation method applied to a mobile terminal as described in any one of the preceding embodiments.

In the mobile terminal provided in this embodiment of the present application, the mobile terminal includes a processor which is configured to perform, when executing a computer program stored in a memory, the intelligent route navigation method applied to a mobile terminal as described in any one of the preceding embodiments. Thus, the mobile terminal has all beneficial effects of the intelligent route navigation method applied to a mobile terminal as described in any one of the preceding embodiments. The beneficial effects will not be repeated here.

The present application provides a computer-readable storage medium storing a computer program which, when executed by a processor, causes the processor to perform the intelligent route navigation method applied to a server or a mobile terminal as described in any one of the preceding embodiments.

In the computer-readable storage medium provided in this embodiment of the present application, the computer-readable storage medium stores a computer program which, when executed by a processor, causes the processor to perform the intelligent route navigation method as described in any one of the preceding embodiments. Thus, the mobile terminal has all beneficial effects of the intelligent route navigation method as described in any one of the preceding embodiments. The beneficial effects will not be repeated here.

Additional aspects and advantages of the present application will be set forth in part in the following description, and will be apparent from the following description or may be learned through practice of the present application.

### BRIEF DESCRIPTION OF DRAWINGS

FIG. 1 is a flowchart of an intelligent route navigation method according to an embodiment of the present application.

FIG. 2 is a flowchart of an intelligent route navigation method according to another embodiment of the present application.

FIG. 3 is a block diagram of an intelligent route navigation device according to an embodiment of the present application.

FIG. 4 is a block diagram of an intelligent route navigation device according to another embodiment of the present application.

FIG. 5 is a flowchart of an intelligent route navigation method according to another embodiment of the present application.

### DETAILED DESCRIPTION

To provide a clearer understanding of objects, features and advantages of the present disclosure, a detailed description of the present disclosure will be given below in conjunction with the drawings and embodiments. It is to be noted that if not in collision, embodiments of the present application and features in the embodiments may be combined with each other.

### Embodiment One

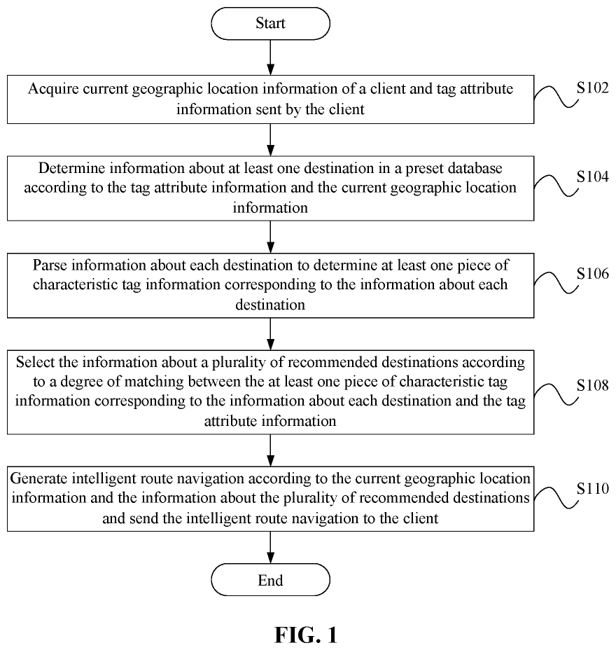

FIG. 1 is a flowchart of an intelligent route navigation method according to an embodiment of the present application.

As shown in FIG. 1, the intelligent route navigation method according to this embodiment of the present application, applied to a server, includes S102 to S110.

In S102, current geographic location information of a client and tag attribute information sent by the client are acquired.

In S104, information about at least one destination is determined in a preset database according to the tag attribute information and the current geographic location information.

In S106, information about each destination is parsed so that at least one piece of characteristic tag information corresponding to the information about each destination is determined.

In S108, the information about a plurality of recommended destinations is selected according to a degree of matching between the tag attribute information and the at least one piece of characteristic tag information corresponding to the information about each destination.

In S110, intelligent route navigation is generated according to the current geographic location information and the information about the plurality of recommended destinations, and the intelligent route navigation is sent to the client.

In this embodiment, the current geographic location information of the client and the tag attribute information sent by the client are acquired to provide data support for intelligent route navigation, helping determine the route satisfying the demand of a user; information about at least one destination is determined in a preset database according to the tag attribute information and the current geographic location information to serve as fundamental data for selection of information about a plurality of recommended destinations; generally, the geographic location in the information about the at least one destination and the geographic location in the current geographic location information are in the same city; information about each destination is parsed so that at least one piece of characteristic tag information corresponding to the information about each destination is determined; the information about the plurality of recommended destinations is selected according to a degree of matching between the at least one piece of characteristic tag information corresponding to the information about each destination and the tag attribute information so that the information about the plurality of recommended destinations is determined, helping determine the route satisfying the demand of the user; intelligent route navigation is generated according to the current geographic location information and the information about the plurality of recommended destinations and the intelligent route navigation is sent to the client, so that the route satisfying the demand of the user is planned out and the user is quickly navigated to a destination. Thus, the intelligent route navigation method is applicable to self-service traveling and is intelligent for the user does not need to give a definite destination.

In an embodiment, the tag attribute information includes, but is not limited to, a human landscape, a historical relic, a pirate ship or a seaside recreation site; the characteristic tag information includes, but is not limited to, whether the seaside is near, whether a barbecue site is provided, whether entertainment facilities are available and whether a cinema is available.

In an embodiment, the tag attribute information may be selected by a user from multiple pieces of tag attribute information displayed on the client or may be generated by the client according to the text information edited and inputted by the user. After generated, the tag attribute information automatically joins a display queue so as to be selected by the user, helping reduce the cumbersome operation of editing and inputting the text information by the user. Meanwhile, the tag attribute information is easy to identify by a server, helping reduce the data interaction pressure of the server, improve the efficiency of generating intelligent route navigation and quickly navigate the user to a destination.

In an embodiment, the client presents a user with multiple pieces of personalized tag attribute information, such as a human landscape, a historical relic, a pirate ship and a seaside recreation site. For example, the user selects two pieces of tag attribute information, the pirate ship and the seaside recreation site. Alternatively, the tag attribute information may be generated by the client according to the text information edited and inputted by the user. The client sends the data of the tag attribute information to the server. According to a prestored intelligent model algorithm, the server can parse out that the user wants to go to a seaside recreation site having at least entertainment facilities such as a pirate ship. The server determines related destination information in the preset database according to the parsing result and the current geographic location information of the client, and then determines characteristic tag information corresponding to the related destination information. For example, as necessary characteristic label information, whether the seaside is near has a larger weight, and whether entertainment facilities such as a pirate ship are available, whether a barbecue site is provided and whether a cinema is available each has a certain score. Destination information having a higher total score, that is, destination information having a higher degree of matching with the tag attribute information, is used as the information about a recommended destination. On this basis, a route is planned and sent to the client so as to be selected and viewed by the user.

In an embodiment, selecting the information about the plurality of recommended destinations according to the degree of matching between the tag attribute information and the at least one piece of characteristic tag information corresponding to the information about each destination includes determining the score of each piece of characteristic tag information corresponding to the information about each destination according to the degree of matching between the tag attribute information and the at least one piece of characteristic tag information corresponding to the information about each destination; weighting the score of the at least one piece of characteristic tag information corresponding to the information about each destination to determine the total score of the information about each destination; and sorting total scores of the information about the at least one destination in descending order and selecting information about a preset number of destinations in sequence as the information about the plurality of recommended destinations.

In this embodiment, the score of each piece of characteristic tag information corresponding to the information about each destination is determined according to the degree of matching between the tag attribute information and the at least one piece of characteristic tag information corresponding to the information about each destination, so that each piece of characteristic tag information corresponding to the information about each destination is quantized, helping determine the route satisfying the demand of a user; the score of the at least one piece of characteristic tag information corresponding to the information about each destination is weighted to determine the total score of the information about each destination, total scores of the information about the at least one destination are sorted in descending order, and information about a preset number of destinations is selected in sequence as the information about the plurality of recommended destinations, so that the route better satisfies the demand of the user and the user can be quickly navigated to a destination. Thus, the intelligent route navigation method is applicable to self-service traveling and is intelligent for the user does not need to give a definite destination.

In an embodiment, the preset number may be 3 to 5 or the preset number may be set by a user.

In an embodiment, for example, if the tag attribute information of a user is a seaside recreation site having at least entertainment facilities such as a pirate ship, then among the at least one piece of characteristic tag information corresponding to the information about each destination, characteristic tag information containing the information that the seaside is near and entertainment facilities are available has a higher score, for example, 5, and other characteristic tag information has a lower score, for example, 1. The score of the at least one piece of characteristic tag information corresponding to the information about each destination is weighted so that the total score of the information about each destination is obtained. On this basis, information about three to five destinations having higher total scores is selected as the information about the recommended destinations.

In any one of the preceding embodiments, the current geographic location information includes a starting location, and information about each recommended destination includes a target location; and generating the intelligent route navigation according to the current geographic location information and the information about the plurality of recommended destinations and sending the intelligent route navigation to the client includes: determining a road condition score corresponding to the information about each recommended destination according to road condition information corresponding to all routes from the starting location to the target location; and sorting all road condition scores corresponding to the information about the plurality of recommended destinations in descending order, generating the intelligent route navigation according to the route corresponding to the maximum road condition score, and sending the intelligent route navigation to the client.

In this embodiment, a road condition score corresponding to the information about each recommended destination is determined according to road condition information corresponding to all routes from the starting location to the target location so that road condition information is taken into account and thus a route better satisfying the demand of a user is determined; all road condition scores corresponding to the information about the plurality of recommended destinations are sorted in descending order, and the intelligent route navigation is generated according to the route corresponding to the maximum road condition score and the intelligent route navigation is sent to the client, so that better intelligent route navigation is provided for the user and the user can be quickly navigated to a destination.

Additionally, after receiving the intelligent route navigation, the user may resend the tag attribute information if the received intelligent route navigation is unsuitable.

In an embodiment, route planning is performed between the selected information about the three to five destinations and the current geographic location information, and road condition information of all routes, such as a congestion degree, a route length and a travelling speed, is acquired in real time. A more congested route has a lower road condition score. A longer route has a lower road condition score. A route in which the travelling speed is lower has a lower road condition score. The road condition scores of all routes are thus obtained. Then, intelligent route navigation is generated according to the route corresponding to the maximum road condition score and the generated intelligent route navigation is sent to the client.

In an embodiment, it is feasible to send the optimal route and alternative routes to the client for selection by a user, and determine a route based on the selection of the user and thereby generate intelligent route navigation.

In any one of the preceding embodiments, the method further includes changing the intelligent route navigation according to real-time road condition information of all routes from a starting location in real-time geographic location information of the client to the target location in the information about each recommended destination and sending the changed intelligent route navigation to the client.

In this embodiment, the intelligent route navigation is changed according to real-time road condition information of all routes from a starting location in real-time geographic location information of the client to the target location in the information about each recommended destination and the changed intelligent route navigation is sent to the client, so that better intelligent route navigation is provided for a user, the user can be quickly navigated to a destination, and thus unnecessary bypasses taken and unnecessary waiting time consumed on a congested road section are reduced.

In an embodiment, during intelligent route navigation, the intelligent route navigation is automatically updated if it is detected in real time that the road condition information of the originally planned route contains information like excessive congestion.

### Embodiment Two

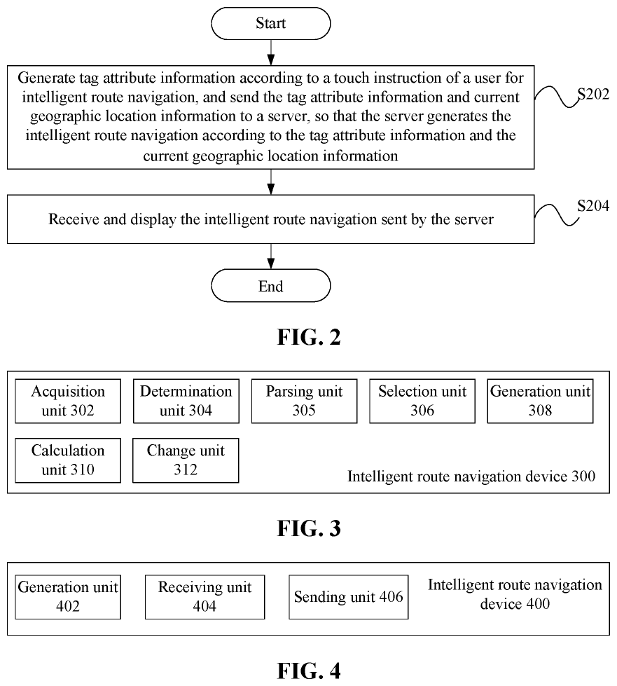

FIG. 2 is a flowchart of an intelligent route navigation method according to another embodiment of the present application.

As shown in FIG. 2, the intelligent route navigation method according to this embodiment of the present application, applied to a client, includes S202 to S204.

In S202, tag attribute information is generated according to a touch instruction of a user for intelligent route navigation, and the tag attribute information and current geographic location information are sent to a server, so that the server generates the intelligent route navigation according to the tag attribute information and the current geographic location information.

In S204, the intelligent route navigation sent by the server is received and displayed.

In this embodiment, tag attribute information is generated according to a touch instruction of a user for intelligent route navigation, and the tag attribute information and current geographic location information are sent to a server, so that intelligent route navigation is generated by the server according to the tag attribute information and current geographic location information, the route satisfying the demand of the user is planned out, the user is quickly navigated to a destination, and thus the intelligent route navigation method is applicable to self-service traveling and is intelligent for the user does not need to give a definite destination; the intelligent route navigation sent by the server is received and displayed so that the intelligent route navigation is displayed to the user, making it achievable for the user to cancel the intelligent route navigation and resend the tag attribute information when the user feels that the received intelligent route navigation is unsuitable and making it achievable for the user to view the whole intelligent route navigation and plan a route by himself or herself.

In an embodiment, the tag attribute information includes, but is not limited to, a human landscape, a historical relic, a pirate ship or a seaside recreation site.

In an embodiment, the tag attribute information may be selected by a user from multiple pieces of tag attribute information displayed on the client or may be generated by the client from the text information edited and inputted by the user. After generated, the tag attribute information automatically joins a display queue so as to be selected by the user, helping reduce the cumbersome operation of editing and inputting the text information by the user. Meanwhile, the tag attribute information is easy to identify by a server, helping reduce the data interaction pressure of the server, improve the efficiency of generating intelligent route navigation and quickly navigate the user to a destination.

In an embodiment, the client presents a user with multiple pieces of personalized tag attribute information, such as a human landscape, a historical relic, a pirate ship and a seaside recreation site. For example, the user selects two pieces of tag attribute information, the pirate ship and the seaside recreation site. Alternatively, the tag attribute information may be generated by the client from the text information edited and inputted by the user. The client sends the data of the tag attribute information to the server. According to a prestored intelligent model algorithm, the server can parse out that the user wants to go to a seaside recreation site having at least entertainment facilities such as a pirate ship. The server determines related destination information in the preset database according to the parsing result and the current geographic location information of the client, and then determines characteristic tag information corresponding to the related destination information. For example, as necessary characteristic label information, whether the seaside is near has a larger weight, and whether entertainment facilities such as a pirate ship are available, whether a barbecue site is provided and whether a cinema is available each has a certain score. Destination information having a higher total score, that is, destination information having a higher degree of matching with the tag attribute information, is used as the information about a recommended destination. On this basis, a route is planned and sent to the client so as to be selected and viewed by the user.

In an embodiment, the method further includes sending real-time geographic location information to the server, so that the server changes the intelligent route navigation according to real-time road condition information of all routes from a starting location in the real-time geographic location information to a target location in information about each recommended destination; and receiving and displaying the changed intelligent route navigation sent by the server.

In this embodiment, real-time geographic location information is sent to the server, so that the server changes the intelligent route navigation according to real-time road condition information of all routes from a starting location in the real-time geographic location information to a target location in information about each recommended destination; the changed intelligent route navigation sent by the server is received and displayed, so that better intelligent route navigation is provided for a user, the user is quickly navigated to a destination, and thus unnecessary bypasses taken and unnecessary waiting time consumed on a congested road section are reduced.

In an embodiment, during intelligent route navigation, the intelligent route navigation is automatically updated if it is detected in real time that the road condition information of the originally planned route contains information like excessive congestion.

### Embodiment Three

FIG. 3 is a block diagram of an intelligent route navigation device 300 according to an embodiment of the present application.

As shown in FIG. 3, the intelligent route navigation device 300 according to this embodiment of the present application, applied to a server, includes: an acquisition unit 302 configured to acquire current geographic location information of a client and tag attribute information sent by the client; a determination unit 304 configured to determine information about at least one destination in a preset database according to the tag attribute information and the current geographic location information; a parsing unit 305 configured to parse information about each destination to determine at least one piece of characteristic tag information corresponding to the information about each destination; a selection unit 306 configured to select information about a plurality of recommended destinations according to a degree of matching between the tag attribute information and the at least one piece of characteristic tag information corresponding to the information about each destination; and a generation unit 308 configured to generate intelligent route navigation according to the current geographic location information and the information about the plurality of recommended destinations, and send the intelligent route navigation to the client.

In this embodiment, the current geographic location information of the client and the tag attribute information sent by the client are acquired to provide data support for intelligent route navigation, helping determine the route satisfying the demand of a user; information about at least one destination is determined in a preset database according to the tag attribute information and the current geographic location information to serve as fundamental data for selection of information about the plurality of recommended destinations; generally, the geographic location in the information about the at least one destination and the geographic location in the current geographic location information are in the same city; information about each destination is parsed so that at least one piece of characteristic tag information corresponding to the information about each destination is determined; the information about the plurality of recommended destinations is selected according to a degree of matching between the at least one piece of characteristic tag information corresponding to the information about each destination and the tag attribute information so that the information about the plurality of recommended destinations is determined, helping determine the route satisfying the demand of the user; intelligent route navigation is generated according to the current geographic location information and the information about the plurality of recommended destinations and the intelligent route navigation is sent to the client so that the route satisfying the demand of the user is planned out and the user is quickly navigated to a destination. Thus, the intelligent route navigation method is applicable to self-service traveling and is intelligent for the user does not need to give a definite destination.

In an embodiment, the tag attribute information includes, but is not limited to, a human landscape, a historical relic, a pirate ship or a seaside recreation site; the characteristic tag information includes, but is not limited to, whether the seaside is near, whether a barbecue site is provided, whether entertainment facilities are available and whether a cinema is available.

In an embodiment, the tag attribute information may be selected by a user from multiple pieces of tag attribute information displayed on the client or may be generated by the client according to the text information edited and inputted by the user. After generated, the tag attribute information automatically joins a display queue so as to be selected by the user, helping reduce the cumbersome operation of editing and inputting the text information by the user. Meanwhile, the tag attribute information is easy to identify by a server, helping reduce the data interaction pressure of the server, improve the efficiency of generating intelligent route navigation and quickly navigate the user to a destination.

In an embodiment, the client presents a user with multiple pieces of personalized tag attribute information such as a human landscape, a historical relic, a pirate ship and a seaside recreation site. For example, the user selects two pieces of tag attribute information, the pirate ship and the seaside recreation site. Alternatively, the tag attribute information may be generated by the client from the text information edited and inputted by the user. The client sends the data of the tag attribute information to the server. According to a prestored intelligent model algorithm, the server can parse out that the user wants to go to a seaside recreation site having at least entertainment facilities such as a pirate ship. The server determines related destination information in the preset database according to the parsing result and the current geographic location information of the client, and then determines characteristic tag information corresponding to the related destination information. For example, as necessary characteristic label information, whether the seaside is near has a larger weight, and whether entertainment facilities such as a pirate ship are available, whether a barbecue site is provided and whether a cinema is available each has a certain score. Destination information having a higher total score, that is, destination information having a higher degree of matching with the tag attribute information, is used as the information about a recommended destination. On this basis, a route is planned and sent to the client so as to be selected and viewed by the user.

In an embodiment, the determination unit 304 is further configured to determine the score of each piece of characteristic tag information corresponding to the information about each destination according to the degree of matching between the tag attribute information and the at least one piece of characteristic tag information corresponding to the information about each destination; the intelligent route navigation device 300 further includes a calculation unit 310 configured to weight a score of the at least one piece of characteristic tag information corresponding to the information about each destination to determine a total score of the information about each destination; and the selection unit 306 is further configured to sort total scores of the information about the at least one destination in descending order and selecting information about a preset number of destinations in sequence as the information about the plurality of recommended destinations.

In this embodiment, the score of each piece of characteristic tag information corresponding to the information about each destination is determined according to the degree of matching between the tag attribute information and the at least one piece of characteristic tag information corresponding to the information about each destination, so that each piece of characteristic tag information corresponding to the information about each destination is quantized, helping determine the route satisfying the demand of a user; the score of the at least one piece of characteristic tag information corresponding to the information about each destination is weighted to determine the total score of the information about each destination, total scores of the information about the at least one destination are sorted in descending order, and information about a preset number of destinations is selected in sequence as the information about the plurality of recommended destinations, so that the route better satisfies the demand of the user and the user can be quickly navigated to a destination. Thus, the intelligent route navigation method is applicable to self-service traveling and is intelligent for the user does not need to give a definite destination.

In an embodiment, the preset number may be 3 to 5 or the preset number may be set by a user.

In an embodiment, for example, if the tag attribute information of a user is a seaside recreation site having at least entertainment facilities such as a pirate ship, then among the at least one piece of characteristic tag information corresponding to the information about each destination, characteristic tag information containing the information that the seaside is near and entertainment facilities are available has a higher score, for example, 5, and other characteristic tag information has a lower score, for example, 1. The score of the at least one piece of characteristic tag information corresponding to the information about each destination is weighted so that the total score of the information about each destination is obtained. On this basis, information about three to five destinations having higher total scores is selected as the information about the recommended destinations.

In any one of the preceding embodiments, the determination unit 304 is further configured to determine a road condition score corresponding to the information about each recommended destination according to road condition information corresponding to all routes from the starting location to the target location; and the generation unit 308 is further configured to sort all road condition scores corresponding to the information about the plurality of recommended destinations in descending order, and generate the intelligent route navigation according to the route corresponding to the maximum road condition score and send the intelligent route navigation to the client.

In this embodiment, a road condition score corresponding to the information about each recommended destination is determined according to road condition information corresponding to all routes from the starting location to the target location, so that road condition information is taken into account and thus a route better satisfying the demand of a user is determined; all road condition scores corresponding to the information about the plurality of recommended destinations are sorted in descending order, and the intelligent route navigation is generated according to the route corresponding to the maximum road condition score and the intelligent route navigation is sent to the client, so that better intelligent route navigation is provided for the user and the user is quickly navigated to a destination.

Additionally, after receiving the intelligent route navigation, the user may resend the tag attribute information if the received intelligent route navigation is unsuitable.

In an embodiment, route planning is performed between the selected information about the three to five destinations and the current geographic location information, and road condition information of all routes, such as a congestion degree, a route length and a travelling speed, is acquired in real time. A more congested route has a lower road condition score. A longer route has a lower road condition score. A route in which the travelling speed is lower has a lower road condition score. The road condition scores of all routes are thus obtained. Then, intelligent route navigation is generated according to the route corresponding to the maximum road condition score and the generated intelligent route navigation is sent to the client.

In an embodiment, it is feasible to send the optimal route and alternative routes to the client for selection by a user, and determine a route based on the selection of the user and thereby generate intelligent route navigation.

In any one of the preceding embodiments, the device further includes a change unit 312 configured to change the intelligent route navigation according to real-time road condition information of all routes from a starting location in real-time geographic location information of the client to the target location in the information about each recommended destination and send the changed intelligent route navigation to the client.

In this embodiment, the intelligent route navigation is changed according to real-time road condition information of all routes from a starting location in real-time geographic location information of the client to the target location in the information about each recommended destination and the changed intelligent route navigation is sent to the client, so that better intelligent route navigation is provided for a user, the user is quickly navigated to a destination, and thus unnecessary bypasses taken and unnecessary waiting time consumed on a congested road section are reduced.

In an embodiment, during intelligent route navigation, the intelligent route navigation is automatically updated if it is detected in real time that the road condition information of the originally planned route contains information like excessive congestion.

### Embodiment Four

FIG. 4 is a block diagram of an intelligent route navigation device 400 according to another embodiment of the present application.

As shown in FIG. 4, the intelligent route navigation device 400 according to this embodiment of the present application, applied to a client, includes a generation unit 402 configured to generate tag attribute information according to a touch instruction of a user for intelligent route navigation, and send the tag attribute information and current geographic location information to a server so that the server generates the intelligent route navigation according to the tag attribute information and the current geographic location information; and a receiving unit 404 configured to receive and display the intelligent route navigation sent by the server.

In this embodiment, tag attribute information is generated according to a touch instruction of a user for intelligent route navigation, and the tag attribute information and current geographic location information are sent to a server, so that the route satisfying the demand of the user is planned out, the user is quickly navigated to a destination, and thus the intelligent route navigation method is applicable to self-service traveling and is intelligent for the user does not need to give a definite destination; the intelligent route navigation sent by the server is received and displayed, so that the intelligent route navigation is displayed to the user, making it achievable for the user to cancel the intelligent route navigation and resend the tag attribute information when the user feels that the received intelligent route navigation is unsuitable and making it achievable for the user to view the whole intelligent route navigation and plan a route by himself or herself.

In an embodiment, the tag attribute information includes, but is not limited to, a human landscape, a historical relic, a pirate ship or a seaside recreation site.

In an embodiment, the tag attribute information may be selected by a user from multiple pieces of tag attribute information displayed on the client or may be generated by the client according to the text information edited and inputted by the user. After generated, the tag attribute information automatically joins a display queue so as to be selected by the user, helping reduce the cumbersome operation of editing and inputting the text information by the user. Meanwhile, the tag attribute information is easy to identify by a server, helping reduce the data interaction pressure of the server, improve the efficiency of generating intelligent route navigation and quickly navigate the user to a destination.

In an embodiment, the client presents a user with multiple pieces of personalized tag attribute information such as a human landscape, a historical relic, a pirate ship and a seaside recreation site. For example, the user selects two pieces of tag attribute information, the pirate ship and the seaside recreation site. Alternatively, the tag attribute information may be generated by the client from the text information edited and inputted by the user. The client sends the data of the tag attribute information to the server. According to a prestored intelligent model algorithm, the server can parse out that the user wants to go to a seaside recreation site having at least entertainment facilities such as a pirate ship. The server determines related destination information in the preset database according to the parsing result and the current geographic location information of the client, and then determines characteristic tag information corresponding to the related destination information. For example, as necessary characteristic label information, whether the seaside is near has a larger weight, and whether entertainment facilities such as a pirate ship are available, whether a barbecue site is provided and whether a cinema is available each has a certain score. Destination information having a higher total score, that is, destination information having a higher degree of matching with the tag attribute information, is used as the information about a recommended destination. On this basis, a route is planned and sent to the client so as to be selected and viewed by the user.

In an embodiment, the device further includes a sending unit 406 configured to send real-time geographic location information to the server, so that the server changes the intelligent route navigation according to real-time road condition information of all routes from a starting location in the real-time geographic location information to a target location in information about each recommended destination; and the receiving unit 404 is further configured to receive and display the changed intelligent route navigation sent by the server.

In this embodiment, real-time geographic location information is sent to the server so that the server changes the intelligent route navigation according to real-time road condition information of all routes from a starting location in the real-time geographic location information to a target location in information about each recommended destination; the changed intelligent route navigation sent by the server is received and displayed, so that better intelligent route navigation is provided for a user, the user is quickly navigated to a destination, and thus unnecessary bypasses taken and unnecessary waiting time consumed on a congested road section are reduced.

In an embodiment, during intelligent route navigation, the intelligent route navigation is automatically updated if it is detected in real time that the road condition information of the originally planned route contains information like excessive congestion.

### Embodiment Five

A server according to this embodiment of the present application includes a processor configured to perform, when executing the computer program stored in a memory, the intelligent route navigation method as described in embodiment one of the present application.

In this embodiment, the server includes a processor configured to perform, when executing a computer program stored in a memory, the intelligent route navigation method as described in embodiment one of the present application. Thus, the server has all beneficial effects of the intelligent route navigation method as described in embodiment one of the present application. The beneficial effects will not be repeated here.

### Embodiment Six

A mobile terminal according to this embodiment of the present application includes a processor configured to perform, when executing a computer program stored in a memory, the intelligent route navigation method as described in embodiment two of the present application.

In this embodiment, the mobile terminal includes a processor configured to perform, when executing a computer program stored in a memory, the intelligent route navigation method as described in embodiment two of the present application. Thus, the mobile terminal has all beneficial effects of the intelligent route navigation method as described in embodiment two of the present application. The beneficial effects will not be repeated here.

### Embodiment Seven

A computer-readable storage medium according to this embodiment of the present application stores a computer program which, when executed by a processor, causes the processor to perform the intelligent route navigation method as described in embodiment one or embodiment two of the present application.

In this embodiment, the computer-readable storage medium stores a computer program which, when executed by a processor, causes the processor to perform the intelligent route navigation method as described in embodiment one or embodiment two of the present application. Thus, the computer-readable storage medium has all beneficial effects of the intelligent route navigation method as described in embodiment one or embodiment two of the present application. The beneficial effects will not be repeated here.

### Embodiment Eight

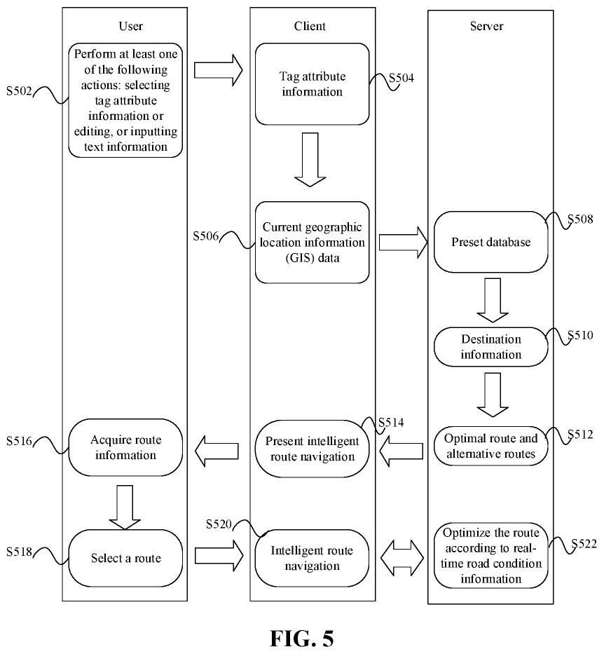

FIG. 5 is a flowchart of an intelligent route navigation method according to another embodiment of the present application.

As shown in FIG. 5, the intelligent route navigation method according to this embodiment of the present application includes S502 to S522.

In S502, a user performs at least one of the following actions: selecting tag attribute information or editing, or inputting text information.

In S504, a client generates tag attribute information.

In S506, the current geographic location information (Geographic Information System or Geo-Information System (GIS)) data of the client is determined.

In S508, a server determines a preset database based on the current geographic location information (GIS) data.

In S510, the server determines destination information in the preset database according to the tag attribute information.

In S512, the server determines the optimal route and alternative routes.

In S514, the client presents intelligent route navigation.

In S516, the user acquires route information.

In S518, the user selects a route.

In S520, the client performs intelligent route navigation according to the route selected by the user.

In S522, the server optimizes the route according to real-time road condition information and updates the intelligent route navigation for the client.

In this embodiment, the route satisfying the demand of the user is planned out according to the tag attribute information of the user and the user is quickly navigated to a destination. Thus, the intelligent route navigation method is applicable to self-service traveling and is intelligent for the user does not need to give a definite destination.

The above is a detailed description of the solution of the present application with reference to the drawings. The present application provides an intelligent route navigation method, an intelligent route navigation device, a server, a mobile terminal and a computer-readable storage medium. In the intelligent route navigation method, intelligent route navigation is performed according to current geographic location information of a client and tag attribute information sent by the client. In this manner, the route satisfying the demand of a user is planned out according to the tag attribute information of the user and the user is quickly navigated to a destination. Thus, the intelligent route navigation method is applicable to self-service traveling and is intelligent for the user does not need to give a definite destination.

The sequence of the steps in the method of the present application may be adjusted according to actual needs. The steps in the method of the present application may be combined or removed according to actual needs.

The units in the device of the present application may be combined, divided or removed according to actual needs.

It is to be understood by those of ordinary skill in the art that all or part of the steps in the methods described in the preceding embodiments may be performed by related hardware instructed by one or more programs, and these programs may be stored in a computer-readable storage medium. The storage medium includes, but is not limited to, a read-only memory (ROM), a random access memory (RAM), a programmable read-only memory (PROM), an erasable programmable read-only memory (EPROM), a one-time programmable read-only memory (OTPROM), an electrically-erasable programmable read-only memory (EEPROM), a compact disk read-only memory (CD-ROM) or another optical disk memory, a magnetic disk memory, a magnetic tape memory, or any other computer-readable storage medium for carrying or storing data.

1. An intelligent route navigation method, applied to a server, comprising:
acquiring current geographic location information of a client and tag attribute information sent by the client;
determining information about at least one destination in a preset database according to the tag attribute information and the current geographic location information;
parsing information about each destination to determine at least one piece of characteristic tag information corresponding to the information about the each destination;
selecting information about a plurality of recommended destinations according to a degree of matching between the tag attribute information and the at least one piece of characteristic tag information corresponding to the information about the each destination; and
generating intelligent route navigation according to the current geographic location information and the information about the plurality of recommended destinations, and sending the intelligent route navigation to the client.

2. The method of claim 1, wherein selecting the information about the plurality of recommended destinations according to the degree of matching between the tag attribute information and the at least one piece of characteristic tag information corresponding to the information about the each destination comprises:
determining a score of each of the at least one piece of characteristic tag information corresponding to the information about the each destination according to the degree of matching between the tag attribute information and the at least one piece of characteristic tag information corresponding to the information about the each destination;
weighting a score of the at least one piece of characteristic tag information corresponding to the information about the each destination to determine a total score of the information about the each destination; and
sorting total scores of the information about the at least one destination in descending order and selecting information about a preset number of destinations in sequence as the information about the plurality of recommended destinations.

3. The method of claim 1, wherein the current geographic location information comprises a starting location, information about each recommended destination comprises a target location, and generating the intelligent route navigation according to the current geographic location information and the information about the plurality of recommended destinations and sending the intelligent route navigation to the client comprises:
determining a road condition score corresponding to the information about the each recommended destination according to road condition information corresponding to all routes from the starting location to the target location; and
sorting all road condition scores corresponding to the information about the plurality of recommended destinations in descending order, generating the intelligent route navigation according to a route corresponding to a maximum one of the road condition scores, and sending the intelligent route navigation to the client.

4. The method of claim 1, further comprising:
changing the intelligent route navigation according to real-time road condition information of all routes from a starting location in real-time geographic location information of the client to the target location in the information about the each recommended destination, and sending the changed intelligent route navigation to the client.

5. An intelligent route navigation method, applied to a client, comprising:
generating tag attribute information according to a touch instruction of a user for intelligent route navigation, and sending the tag attribute information and current geographic location information to a server, so that the server generates the intelligent route navigation according to the tag attribute information and the current geographic location information; and
receiving and displaying the intelligent route navigation sent by the server.

6. The method of claim 5, further comprising:
sending real-time geographic location information to the server so that the server changes the intelligent route navigation according to real-time road condition information of all routes from a starting location in the real-time geographic location information to a target location in information about each recommended destination; and
receiving and displaying the changed intelligent route navigation sent by the server.

7. An intelligent route navigation device for performing the method of claim 1, applied to a server, comprising:
an acquisition unit, which is configured to acquire current geographic location information of a client and tag attribute information sent by the client;
a determination unit, which is configured to determine information about at least one destination in a preset database according to the tag attribute information and the current geographic location information;
a parsing unit, which is configured to parse information about each destination to determine at least one piece of characteristic tag information corresponding to the information about the each destination;
a selection unit, which is configured to select information about a plurality of recommended destinations according to a degree of matching between the tag attribute information and the at least one piece of characteristic tag information corresponding to the information about the each destination; and
a generation unit, which is configured to generate intelligent route navigation according to the current geographic location information and the information about the plurality of recommended destinations, and send the intelligent route navigation to the client.

8. The device of claim 7, wherein
the determination unit is further configured to determine a score of each of the at least one piece of characteristic tag information corresponding to the information about the each destination according to the degree of matching between the tag attribute information and the at least one piece of characteristic tag information corresponding to the information about the each destination;
the intelligent route navigation device further comprises:
a calculation unit, which is configured to weight a score of the at least one piece of characteristic tag information corresponding to the information about the each destination to determine a total score of the information about the each destination; and
the selection unit is further configured to sort total scores of the information about the at least one destination in descending order and select information about a preset number of destinations in sequence as the information about the plurality of recommended destinations.

9. The device of claim 7, wherein the current geographic location information comprises a starting location and information about each recommended destination comprises a target location;
the determination unit is further configured to determine a road condition score corresponding to the information about the each recommended destination according to road condition information corresponding to all routes from the starting location to the target location; and
the generation unit is further configured to sort all road condition scores corresponding to the information about the plurality of recommended destinations in descending order, generate the intelligent route navigation according to a route corresponding to a maximum one of the road condition scores, and send the intelligent route navigation to the client.

10. (canceled)

11. An intelligent route navigation device for performing the method of claim 5, applied to a client, comprising:
a generation unit, which is configured to generate tag attribute information according to a touch instruction of a user for intelligent route navigation, and send the tag attribute information and current geographic location information to a server, so that the server generates the intelligent route navigation according to the tag attribute information and the current geographic location information; and
a receiving unit, which is configured to receive and display the intelligent route navigation sent by the server.

12. (canceled)

13. A server, comprising a memory, a processor, and a computer program stored in the memory and executable by the processor, wherein the processor is configured to perform, when executing the computer program, the following steps:
acquiring current geographic location information of a client and tag attribute information sent by the client;
determining information about at least one destination in a preset database according to the tag attribute information and the current geographic location information;
parsing information about each destination to determine at least one piece of characteristic tag information corresponding to the information about the each destination;
selecting information about a plurality of recommended destinations according to a degree of matching between the tag attribute information and the at least one piece of characteristic tag information corresponding to the information about the each destination; and
generating intelligent route navigation according to the current geographic location information and the information about the plurality of recommended destinations, and sending the intelligent route navigation to the client.

14. A mobile terminal, comprising a memory, a processor, and a computer program stored in the memory and executable by the processor, wherein the processor is configured to perform, when executing the computer program, the intelligent route navigation method of claim 5.

15. A non-transitory computer-readable storage medium, wherein the storage medium stores a computer program which, when executed by a processor, causes the processor to perform the intelligent route navigation method of claim 1.

16. The method of claim 2, further comprising:
changing the intelligent route navigation according to real-time road condition information of all routes from a starting location in real-time geographic location information of the client to the target location in the information about the each recommended destination, and sending the changed intelligent route navigation to the client.

17. The method of claim 3, further comprising:
changing the intelligent route navigation according to real-time road condition information of all routes from a starting location in real-time geographic location information of the client to the target location in the information about the each recommended destination, and sending the changed intelligent route navigation to the client.

18. The server of claim 13, wherein the processor is further configured to perform the following steps:
determining a score of each of the at least one piece of characteristic tag information corresponding to the information about the each destination according to the degree of matching between the tag attribute information and the at least one piece of characteristic tag information corresponding to the information about the each destination;
weighting a score of the at least one piece of characteristic tag information corresponding to the information about the each destination to determine a total score of the information about the each destination; and
sorting total scores of the information about the at least one destination in descending order and selecting information about a preset number of destinations in sequence as the information about the plurality of recommended destinations.

19. The server of claim 13, wherein the processor is further configured to perform the following steps:
determining a road condition score corresponding to the information about the each recommended destination according to road condition information corresponding to all routes from the starting location to the target location; and
sorting all road condition scores corresponding to the information about the plurality of recommended destinations in descending order, generating the intelligent route navigation according to a route corresponding to a maximum one of the road condition scores, and sending the intelligent route navigation to the client.

20. The server of claim 13, wherein the processor is further configured to perform the following steps:
changing the intelligent route navigation according to real-time road condition information of all routes from a starting location in real-time geographic location information of the client to the target location in the information about the each recommended destination, and sending the changed intelligent route navigation to the client.

21. The mobile terminal of claim 14, wherein the processor is further configured to perform the following steps:
sending real-time geographic location information to the server so that the server changes the intelligent route navigation according to real-time road condition information of all routes from a starting location in the real-time geographic location information to a target location in information about each recommended destination; and
receiving and displaying the changed intelligent route navigation sent by the server.

22. A non-transitory computer-readable storage medium, wherein the storage medium stores a computer program which, when executed by a processor, causes the processor to perform the intelligent route navigation method of claim 5.
